(19) United States
(12) Patent Application Publication
(10) Pub. No.: US 2003/0231656 A1
(43) Pub. Date: Dec. 18, 2003

(54) Method, medium access controller, control module, terminating device and terminating module for allocating transmission capacity of a shared medium in a multipoint-to-point network

(75) Inventor: Stefan Wahl, Schwieberdingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/458,674

(22) Filed: Jun. 11, 2003

(30) Foreign Application Priority Data
Jun. 13, 2002 (EP) 02360174.3

(51) Int. Cl. H04J 3/16

(52) U.S. Cl. 370/468; 370/445

(57) ABSTRACT

The present invention relates to a method and devices for allocating transmission capacity of a shared medium in a multipoint-to-point network, in which the shared medium is provided for a plurality of terminating devices for transmitting data to one point and a network-side medium access controller is provided for allocating transmission capacity of the medium to the terminating devices, comprising the steps of: grouping of data to be transmitted on the medium in a first and in a second data category if the data conform or do not conform, respectively, to a specified criterion, allocation of transmission capacity of the medium for the first data category by the medium access controller, transmitting the data of the first data category on the medium with account being taken of the allocated transmission capacity, and transmitting the data of the second data category on the medium.

### BACKGROUND OF THE INVENTION

The invention is based on a priority application EP 02360174.3 which is hereby incorporated by reference.

The present invention relates to a method for allocating transmission capacity of a shared medium in a multipoint-to-point network, in which the shared medium is provided for a plurality of terminating devices for transmitting data to one point and a network-side medium access controller is provided for allocating transmission capacity of the medium to the terminating devices. The invention furthermore relates to a multipoint-to-point network, a medium access controller, a control module, a terminating device and a terminating module for this purpose.

In a multipoint-to-point network, data are transmitted in a downlink direction from a central point to a plurality of points, for example to terminating devices and/or in an uplink direction from a plurality of points to the central point. In said network, a shared medium may be provided for a plurality of terminating devices for transmitting data to the central point and/or in the reverse direction. The shared medium, for example a radio channel or a shared data line, is used by a plurality of subscribers. A typical example of a multipoint-to-point network is an access network, for example an HFC (hybrid fiber-coax) network or a UMTS (universal mobile telecommunications system) radio cell. In the so-called downlink direction, the use of a shared medium is comparatively problem-free. The terminating devices receive the data transmitted on the medium and evaluate them insofar as they are relevant for them. In the reverse direction, the “uplink direction”, this is, however, substantially more difficult. The transmission capacity available on the medium must be partitioned over the terminating devices according to a predetermined scheme so that transmission collisions do not occur on the medium if a plurality of terminating devices wish to use a shared uplink transmission capacity at the same time. In distributing the transmission capacity, the current transmission requirements of the terminating devices should however be taken into account as much as possible.

One way of allocating the uplink transmission capacity is that predetermined transmission capacities are made available to each of the terminating devices for different qualities of data to be transmitted. The data are grouped by the terminating devices into quality-of-service categories, which are also termed QoS categories (QoS=quality of service). The quality-of-service categories correspond to the quality of service necessary in each case for data to be transmitted, i.e. there are, for example, data that are assigned to a higher quality of service, for example real-time data, and data for which a lower quality of service is adequate, for example data requirements imposed on the Internet that are not time-critical. A terminating device groups data on the basis of specified criteria in the quality-of-service categories.

To transmit the data of each data category, a network-side medium access controller (MAC) provides a predetermined transmission capacity on the respective shared medium for the terminating devices. In this connection, the medium access controller of each terminating device allocates, for example, time slots in which the terminating device is allowed to transmit data of a first quality-of-service category and time slots in which the terminating device is allowed to transmit data of a second quality-of-service category subordinate to the first quality-of-service category. The terminating devices transmit the data of the quality-of-service categories taking account of the transmission capacity, allocated therefor, on the shared medium.

Problems are presented by data that do not conform to a specified criterion for one or more quality-of-service categories. Possibly, said data cannot be assigned to a quality-of-service category. Furthermore, data may be categorized as “nonconformal” if they cannot be transmitted within the transmission capacity provided for the respective quality-of-service category. Said nonconformal data are, for example, immediately dropped, prepared for dropping or grouped in a lower-value quality-of-service category. Undesired subscriber-side data losses and/or delayed transmission of such nonconformal data may therefore occur.

### SUMMARY OF THE INVENTION

The object of the invention is therefore to improve the allocation of transmission capacity in a shared medium in the case of a multipoint-to-point network in which the shared medium is provided for a plurality of terminating devices for transmitting data to one point and a network-side medium access controller is provided for allocating transmission capacity in the medium to the terminating devices.

This object is achieved by a method in accordance with the technical teaching of method for allocating transmission capacity of a shared medium in a multipoint-to-point network, in which the shared medium is provided for a plurality of terminating devices for transmitting data to one point and a network-side medium access controller is provided for allocating transmission capacity of the medium to the terminating devices, comprising the steps of: grouping of data to be transmitted on the medium in a first data category if the data conform to a specified criterion and in a second data category if the data do not conform to the specified criterion by a terminating device connected to the medium, allocation of transmission capacity of the medium for the first data category by the medium access controller, transmission of the data of the first data category on the medium with account being taken of the allocated transmission capacity by the terminating device, at least partial release of unused transmission capacity available on the shared medium for the transmission of the data of the second data category, transmission of the data of the second data category on the medium within the scope of the transmission capacity released therefor. Furthermore, to achieve the object, a multipoint-to-point network, a medium access controller, a control module, a terminating device and a terminating module in accordance with further independent claims are provided.

In this connection, the invention is based on the idea that at least one terminating device connected to the shared medium groups the data to be transmitted in each case on the medium by the terminating device into a first data category if the data conform to a specified criterion. Data not conforming to the criterion are grouped by the respective terminating device in a second data category. The first data category corresponds, for example, to a predetermined quality of service. The data of the second data category do not conform to said quality of service. It is possible, for example, that the terminating device cannot precisely assign the data of the second data category to a quality of service, but that, although the data do not conform to the first data category, they come closest to the quality of service of the first data category. Furthermore, a predetermined transmission capacity that is reserved for the terminating device for the quality of service on the shared medium may already be fully loaded by the data of the first data category. Further data that are additionally to be transmitted in the quality of service, but cannot be transmitted because of the already fully loaded transmission capacity, are grouped as “nonconformal” data in the second data category.

It is also possible for the procedure also to be adopted in the manner according to the invention for further service qualities. The terminating device according to the invention groups the data to be transmitted with respect to said quality of service in each case in the two data categories for conformal and nonconformal data.

Preferably, all the terminating devices connected to the shared medium, but at least a plurality of them, group their respective data to be transmitted via the medium in the manner according to the invention for each quality of service, but at least for one quality of service, in a first and a second data category respectively.

The medium access controller allocates the transmission capacity of the medium to the terminating devices in the direction of one point, namely in the so-called uplink direction or upstream direction. It is obvious that, in principle, data can also be transmitted on the shared medium to the terminating devices, that is to say in the so-called downlink direction or downstream direction.

The medium access controller allocates the transmission capacity necessary for the first data category, that is to say it grants, so to speak, said transmission capacity. The terminating devices transmit the data grouped in the first data category taking account of the allocated transmission capacity.

In contrast to the known procedure, however, the data that do not conform to the first data category, namely the data of the second data category, are not simply erased or transmitted without further ado with a lower-value quality of service. On the contrary, the medium access controller releases at least partly, but preferably completely, unused transmission capacity on the shared medium for the transmission of the data of the second data category. The respective terminating device transmits the data of the second data category within the framework of the transmission capacity released therefor on the shared medium.

The unused transmission capacity may be, for example, transmission capacity that is reserved for the data of the first data category of a single, individual quality of service and is not fully loaded. Preferably, however, a plurality of service qualities is provided in each case with a first and a second data category. The medium access controller then determines the extent to which the transmission capacity is necessary for transmitting the data in the respective first data categories of different quality of service. If transmission capacity is then still available on the shared medium, the medium access controller releases it for transmitting data of the second data categories.

The medium access controller can release the unused transmission capacity on the basis of service qualities. In this connection, prioritization of higher-value service qualities is, for example, possible. That is to say, the medium access controller releases the unused transmission capacity as a matter of priority for the transmission of data of a second data category having a higher-value quality of service. It is also possible for the medium access controller to leave to the terminating device whether it transmits data of a higher or a lower quality of service within the scope of the released transmission capacity. In this case, the release would be, so to speak, overall. For example, the terminating device can then determine whether it transmits data of a second data category having a higher quality of service or, instead of the latter, data of a second data category having a lower quality of service, for example so-called best-effort data.

It is possible for the “non-utilization” of transmission capacity of a data category to relate in each case individually to a terminating device i.e. that a terminating device is allowed to use the transmission capacity it does not itself use in each case for one or more first data categories for one or more second data categories. It is, however, preferable that the medium access controller takes account of all the terminating devices connected to the shared medium and releases transmission capacity for the transmission of data of the second data categories if the released transmission capacity is not needed by any of the terminating devices for the transmission of data in the first data categories.

It is obvious that the medium access controller can also allocate or release the transmission capacities for the two data categories in one step, for example by means of a single release message. The terminating device can likewise transmit the data of the two data categories in combination with one another, for example in a single message.

The transmission capacity of the shared medium is optimally used by the invention. This is advantageous both for the network operator and for the subscribers that use the terminating devices connected to the medium. On the other hand, it is guaranteed that transmission capacity is provided for the data of the first data category to an adequate extent. If necessary, the data of the second data category are erased, for example, in a known manner or transmitted with a lower quality of service. An overload situation of the shared medium can in this way be avoided despite the increased loading of the medium.

The term “terminating device” in the context of the invention must be understood in a wide sense, namely as a device for terminating a shared transmission path controlled by the medium access controller. Further telecommunications devices, for example terminals or the like, that are given access to the transmission path via the terminating device according to the invention may be connected to the terminating device according to the invention. For example, a terminating device according to the invention may be a so-called set-top box for connecting a television set. A terminating device according to the invention may also be, for example, a so-called “access network termination”. A terminating device according to the invention may, however, also form an integral component of a terminal. A terminating device according to the invention may also be designed as a terminal.

The medium access controller may, for example, form a component of a network-side network device for terminating a transmission path that comprises the shared medium. It is also possible for the medium access controller to form, in total, such a network device.

It is obvious that hardware and software components, preferably in combination with one another, can be used to implement the invention. Accordingly, to achieve the object there are provided, in accordance with further independent claims, a medium access controller and a terminating device, which tend to be hardware-oriented, and a control module and also a terminating module that form software provided for interaction with a hardware device.

The multipoint-to-point network comprises or is, for example, an access network, in particular a hybrid fiber-coax network and/or a universal mobile telecommunications system and/or a wireless LAN (=local area network) and/or an LMDS (local multipoint distributive system). The method according to the invention is preferably used in the uplink direction.

Further advantageous embodiments and effects of the invention emerge from the dependent claims and the description.

Preferably, the terminating device transmits an information item by means of the data, to be transmitted on the medium, of the first and/or the second data category to the medium access controller. The information item may, for example, relate to the quality of service necessary for the data. The medium access controller can optimally allocate, as a function of the information item, the transmission capacity, available for the first data category, for the transmission of the data of the first or the second data category. The information item is transmitted by the terminating devices, for example, spontaneously, for example as piggyback information for the payload. It is also possible for the medium access controller to scan the information item at the terminating devices, for example within the scope of a polling method. In principle, the terminating devices can also then transmit their responses as piggyback information for the useful data.

It is obvious that, for example, one information item about the data of the first data category to be transmitted on the medium is also basically adequate. The medium access controller can then, for example, determine transmission capacity not currently necessary for the first data category, but available on the medium and, for example, release in each case a portion of this unused transmission capacity as a whole to the terminating devices for transmitting data of the second data category. This release may be independent of whether the respective terminating device has currently data to transmit in the second data category.

The information item may also relate, for example, to the quantity and/or the content of the data to be transmitted in each case in the first or the second data category. On the basis of the quantity information, the medium access controller can instruct, for example, a terminating device to erase a part of the data of the second data category and to transmit another part within the scope of transmission capacity available for the first data category, but not currently used.

Preferably, the information item is contained in a transmission request communicated to the medium access controller. A terminating device registers, so to speak, its need for transmission capacity by means of the transmission request. At the same time, the terminating device indicates, for example, the respective quantity and/or quality of the data awaiting transmission in the first data category and in the second data category.

As already explained, the medium access controller can allocate the transmission capacity available for the first data category optimally for the first data category and for the second data category for each of the individual terminating devices. Advantageously, however, the medium access controller releases unused transmission capacity for the transmission of the data of the second data category as a function of the amount of data to be transmitted in each case in the first data categories in the case of all the terminating devices connected to the medium, or, at any rate, in the case of a group of terminating devices connected to the medium. The medium access controller first receives, for example, information items about the data to be transmitted in total on the medium in the two data categories from all the terminating devices or from the group of terminating devices transmitting via the medium. Then the medium access controller allocates the transmission capacity available for the first data categories as a matter of priority to the data of the first data categories. If transmission capacity is then still present, it is distributed, for example evenly, over the terminating devices for the transmission of data of the second data categories.

Particularly preferred is a foresighted mode of operation in implementing the invention: the transmission capacity available on the medium is distributed in advance for each allocation period. The terminating devices register in advance, for example for an allocation period, the data to be transmitted by them in each of the two data categories. For this purpose, the terminating devices transmit, for example, in-band signaling messages and/or out-band signaling messages. The medium access controller then allocates the transmission capacity for this next allocation period to the terminating devices.

Preferably, the terminating devices arrange the data of the first data category to be transmitted on the medium in a first queue and the data of the second data category in a second queue. The data are then placed in the queues segmented, for example, as cells or packets. If a terminating device assigns the data to different service qualities in each case, two queues may, for example, be provided in each of the service qualities: a first queue for data of the first data category and a second queue for data of the second data category in each case.

In principle, the transmission capacity available on the shared medium can be partitioned in any desired manner, for example in transmission channels, transmission codes, transmission frequencies or the like. As examples, mention may be made, for example, of frequency-division multiple access (FDMA) and code-division multiple access (CDMA). Preferably, the transmission capacity of the medium is divided into time slots, for example by means of time-division access (TDA), time-division multiple access (TDMA), etc. The transmission capacity is partitioned into said time slots and allocated for the transmission of the data of the first and of the second data categories.

As explained, the medium access controller ensures that a terminating device is able to transmit the data of the second data category (categories) as completely as possible within the scope of the hitherto unused transmission capacity. However, situations may arise in which not all the data of the second data category (categories) can be transmitted. In such a scenario, the medium access controller preferably transmits erase commands for at least a part of the data grouped in the second data category to the terminating device(s). In principle, however, it would be possible for the terminating devices to erase the data that cannot be sent of their own accord, i.e. without such an erase command.

Expediently, the second data category is a data category subordinate to the first data category. The data of the first data category are preferably transmitted as a matter of priority.

### BRIEF DESCRIPTION OF THE DRAWINGS

The invention is presented below with reference to exemplary embodiments using the figures. In the figures:

FIG. 1 shows a telecommunications network according to the invention for implementing the method according to the invention, having terminating devices according to the invention and also a medium access controller, according to the invention, for allocating transmission capacity of a wireless shared medium,

FIG. 2 shows a variant of the telecommunications network in accordance with FIG. 1, wherein, however, a transmission capacity of a line-connected shared medium is allocated,

FIG. 3 shows a diagrammatic representation of a medium access controller according to the invention and also of a terminating device, according to the invention, interacting with the latter,

FIG. 4 shows a diagrammatic structure of the terminating device in accordance with FIG. 3,

FIG. 5 shows a diagrammatic structure of the medium access controller in accordance with FIG. 3,

FIG. 6 shows a communication procedure between the medium access controller and the terminating device in accordance with FIG. 3, and

FIG. 7 shows a communication procedure, alternative to the procedure illustrated in FIG. 6, between the medium access controller and the terminating device in accordance with FIG. 3.

### DETAILED DESCRIPTION OF THE DRAWINGS

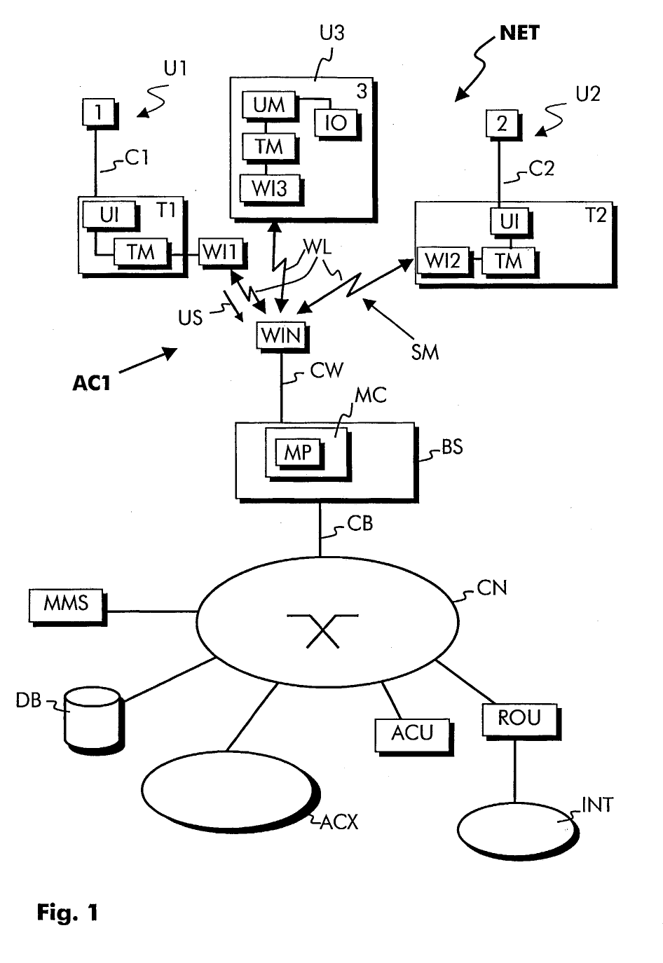

FIG. 1 shows an exemplary arrangement with which the invention can be implemented. FIG. 1 shows a telecommunications network NET that comprises an access network AC1 according to the invention. The access network AC1 has, at least partly, a multipoint-to-point structure. Terminals 1 to 3 shown by way of example are given access to a core network CN of the network NET via the access network AC1. The core network CN comprises, for example, an ATM (=asynchronous transfer mode) network and/or an SDH (=synchronous digital hierarchy) network. Preferably, the core network CN guarantees at any rate at least a predetermined quality of service (QoS=quality of service). The core network CN comprises in the present case, for example, an ATM node or is formed by an ATM node.

The terminals 1 to 3 can receive multimedia data, for example video films or the like, from a multimedia server MMS connected to the core network CN via a connection CM. Furthermore, the terminals 1 to 3 can scan data of a data base DB connected to the core network CN. Via a router ROU connected to the core network CN, the terminals 1 to 3 obtain access to the Internet INT or another network connected to the telecommunications network NET. Furthermore, further access networks ACX may be connected to the core network CN, for example an HFR (=hybrid fiber radio) network, a symmetrical or asymmetrical DSL (=digital subscriber line) network, a wireless and/or cable-connected FTTH (=fiber to the home) network or the like. A control and management device ACU (access control unit) controls and manages the access networks ACX and also the access network AC1.

In the exemplary embodiment in accordance with FIG. 1, the access network AC1 is a wireless access network. The access network AC1 is, for example, an LMDS (=local multipoint distributive/distribution service), a wireless LAN (local area network), a UMTS (=universal mobile telecommunications system) network or the like. The access network AC1 and also, in the present case, the access networks ACX have shared media in the so-called upstream direction US (from the terminals to the core network CN). The access network AC1 is, for example, a shared medium SM. A shared medium, for example a so-called distribution channel, may also be provided in the so-called downstream direction DS (from the core network CN to the terminals). It is also possible for a single shared medium, for example the shared medium SM, to be used in the upstream and downstream direction US, DS. In the downstream direction DS and in the upstream direction US, for example, video data, call data, control data for retrieving video data or the like are communicated.

To control the data transmission on the medium SM in the upstream direction from the terminals 1 to 3 to the core network CN, there is provided in the case of the access network AC1 a medium access controller MC according to the invention that in the present case forms a component of a base station BS. The essential functions for controlling the upstream transmission capacity of the medium SM of the medium access controller MC are implemented by a software-oriented control module MP according to the invention. However, the medium access controller MC could also be designed completely in hardware.

The base station BS is connected via a connection CB to the core network CN over which data are transmitted, for example, in ATM cells and/or synchronous transport modules (STM) in SDH technology or the like. The base station BS is connected via a connection CW to a radio interface module WIN via which the base station BS can transmit data wirelessly to the terminals 1 to 3 and can receive data from the latter. The terminals 1 to 3 transmit data in the upstream direction US, for example, on a predetermined shared radio channel, which consequently forms the shared medium SM. In the upstream direction US, data are transmitted from a plurality of points, in the present case the terminating devices T1, T2 and the terminal 3, in the direction of one point, in the present case the base station BS, on the shared medium SM.

The terminals 1 and 2, which are, for example, personal computers, telephones, personal digital assistants, etc., are assigned terminating devices T1 and T2 according to the invention for transmitting and receiving data on the shared medium SM. The terminating devices T1 and T2 could indeed be designed in principle as pure hardware solutions. In the exemplary embodiment, however, they comprise terminating modules TM according to the invention whose program code they execute. The terminating device T2 integrally comprises a radio interface WI2 for communication via the shared medium SM. Connected to the terminating device T1 is a radio interface module WI1 that is designed as a separate module and that serves to set up a radio connection WL to the network-side radio interface module WIN and, consequently, serves to communicate via the shared medium SM. The terminals 1 and 2 are connected to the terminating devices T1 and T2 via connections C1 and C2 for which user interfaces UI are provided at the terminating devices T1 and T2. The user interfaces UI support, for example, communication via Ethernet and/or ATM or the like. For example, ATM communication with approximately 25 Mbit/s, 155 Mbit/s or more is provided. Further terminals, not shown, could also be connected to the terminating devices T1 and T2 in addition to the terminals 1, 2.

The terminal 3 is, so to speak, an integrated solution: it comprises a software-oriented terminating module TM according to the invention and also a radio interface WI3 for transmitting and receiving data on the shared medium. The terminal device 3 consequently forms, so to speak, a terminating device according to the invention and is partly denoted below also as “terminating device 3”. In addition, the terminal 3 comprises input and output means 10, for example a keyboard and a mouse or a display and a loudspeaker at which operating commands can be inputted or the data can be outputted. In addition, the terminal device 3 has user program modules, for example a browser UM for the Internet INT or the like.

The terminal 1 and the terminating device T1, and also the radio interface WI1 are, for example, allocated to a user U1 and form his so-called customer premises equipment (CPE). The terminal 2 and the terminating device T2 belong to a user U2 and the terminal 3 belongs to a user U3.

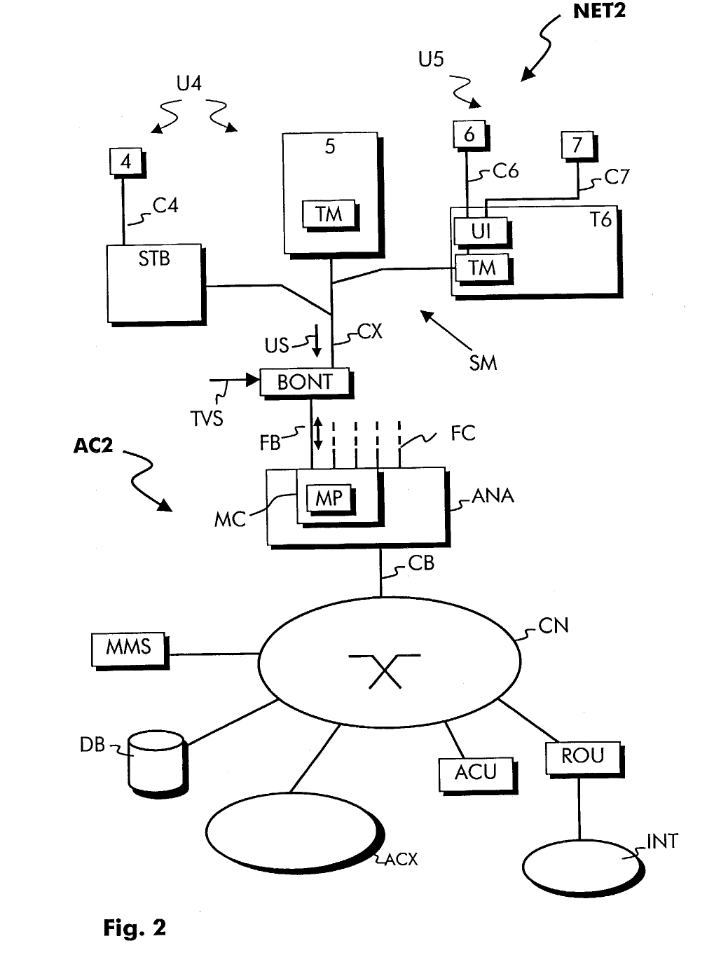

FIG. 2 shows a variant of the telecommunications network NET in accordance with FIG. 1 having an access network AC2 instead of the access network AC1. Insofar as the components of the telecommunications network NET2 in FIG. 2 correspond to those from FIG. 1, they are provided with the same reference symbols and are not explained further below. In contrast to the access network AC1, the access network AC2 is a wire-connected access network, for example a hybrid fiber-coax (HFC) network, a powerline communication network (communication via an energy distribution network) or the like. Terminals 4 to 7 obtain access to the core network CN via the access network AC2. In the present case, the access network AC2 is an HFC network. On the access network AC2, communication is, for example, according to the standards of the DAVIC (Digital Audio Visual Council), the DVB (digital video broadcasting) organization and/or the Data Over Cable Service Interface Specification (DOCSIS). In the case of the access network AC2, a coaxial-cable connection CX comprising one or more coaxial cables serves as shared medium SM, the transmission capacity of at least one cable being used at least partly by a plurality of terminals in the upstream or uplink direction US.

Instead of the base station BS and also the radio interface module WIN, an access network adapter ANA (=access network adaptation) and also an amplifier BONT (=broadband optical network termination) are provided in the case of the access network AC2. The access network adapter ANA, which in the present case can also be described as a head end, essentially corresponds to the base station BS in the case of the invention. It likewise comprises a medium access controller MC and also a control module MP for controlling the transmission capacity of a shared medium SM, which, in the case of the access network AC2, is formed by an optical connecting line FB between the adapter ANA and the amplifier BONT and also the coaxial-cable connection CX. The adapter ANA may also serve further optical connecting lines FC, for example optical fibers, that lead to access network adapters that are not shown.

Data are transmitted on the coaxial-cable connection CX in the upstream direction US and in the downstream direction DS. For example, one or more transmission frequencies are reserved in each case for the upstream direction US and for the downstream direction DS. Preferably, the transmission capacity in the upstream direction US is less than in the downstream direction DS. For example, an ATM communication is provided downstream with 34 Mbit/s or upstream with 2.15 Mbit/s. As also in the case of the radio connection WL, various modulation methods may be used, for example QAM (quadrature amplitude modulation), QPSK (quadrature phase shift keying), DQPSK (=differential QPSK), etc. In any case, the terminals 4-7 competitively seize the shared medium SM at least in the upstream direction US. The transmission capacity necessary in the upstream direction US is allocated to the terminals 4-7 by the adapter ANA, in particular the medium access controller MC. In the downstream direction DS, there are additionally injected at the amplifier BONT television signals TVS that are transmitted on the connection CX to the terminals 4-7. In principle, the television signals TVS could also be injected into the adapter ANA.

The terminal 4 is, for example, a television set that is connected via a connection C4 to a so-called set-top box STB. The STB forms a terminating device according to the invention and is connected to the coaxial-cable connection CX. A terminating device according to the invention likewise forms the terminal 5 that is connected to the connection CX and that is, for example, a personal computer. The terminals 4 and 5 form the so-called customer premises equipment (CPE) of a user U4. A terminating device T6 is connected to the connection CX and serves the terminals 6 and 7, for example telephones, computers, etc. of a user U5 via connections C6, C7. The terminal 5 and the terminating device T6 each contain a terminating module TM according to the invention.

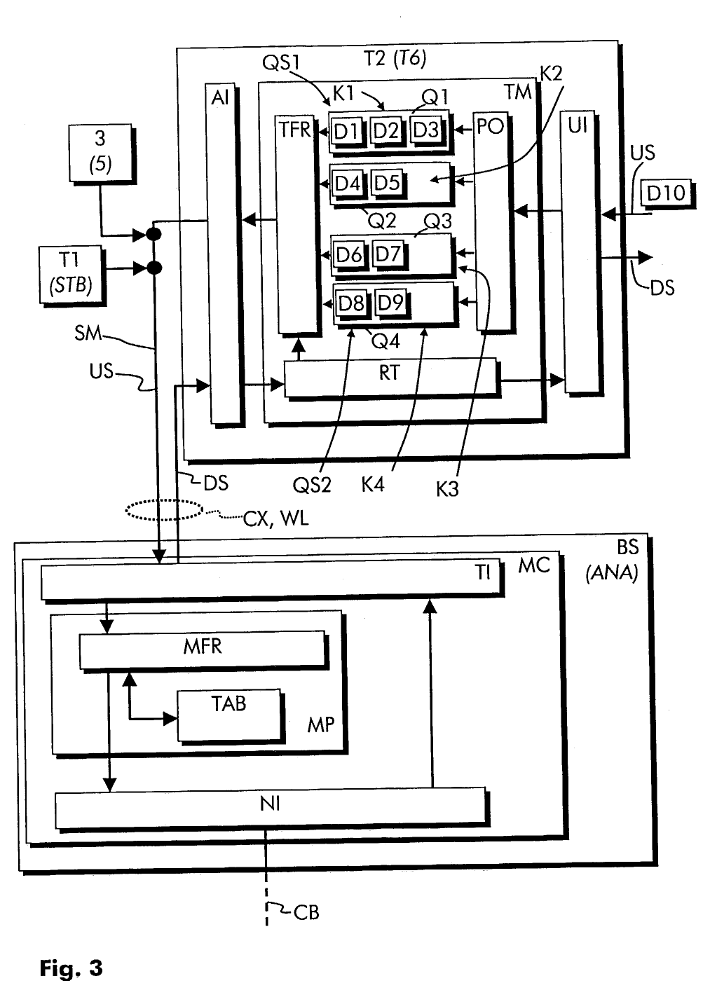

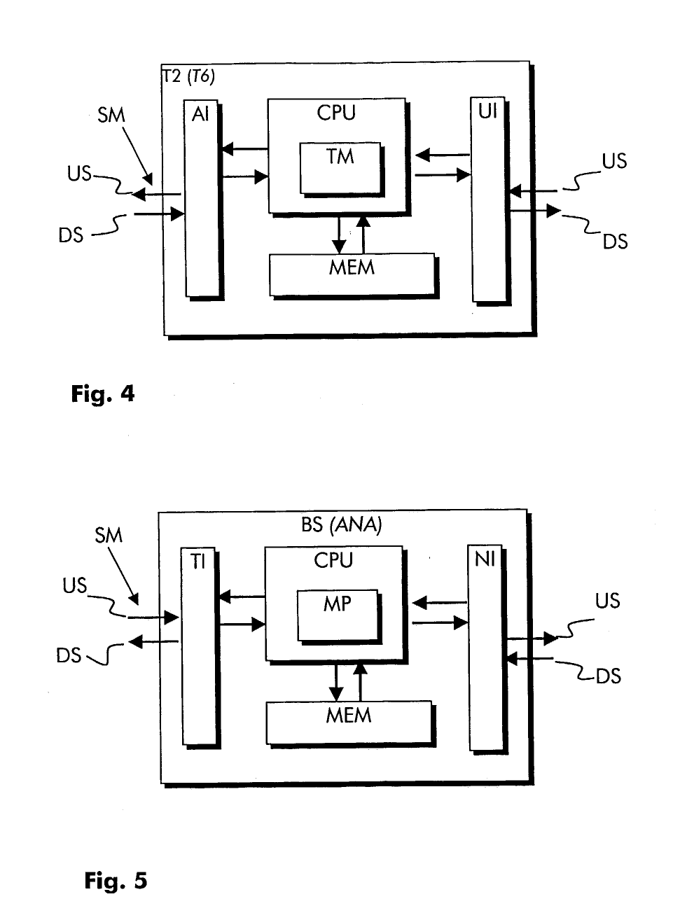

The functions of a terminating device according to the invention, represented, for example, by the terminating devices T2 and T6, and of a medium access controller according to the invention, represented, for example, by the base station BS and the adapter ANA, are described in greater detail below on the basis of the diagrammatic, functional representations in FIGS. 3 to 5 (the reference symbols in italics and written in brackets in FIGS. 3 to 5 relate to the network NET2 in accordance with FIG. 2). For reasons of simplification, however, reference is made below only to the terminating device T2 and the base station BS.

The terminating device T2 and the base station BS have control means CPU and also memory means MEM. The control means CPU is, for example, a processor with which a program code can be executed that is stored in the memory means MEM. The memory means MEM is, for example, a RAM (=random access memory), so-called flash ROM (=read only memory) modules and/or a hard disk. For example, there is stored in the memory means MEM of the terminating device T2 a terminating module TM according to the invention whose program code is executed by the control means CPU. Stored in the memory means MEM of the base station BS is a control module MP according to the invention whose program code is executed by the control means CPU. The terminating device T2 has an interface AI and the base station BS an interface TI to the shared medium SM. The base station BS has an interface NI to the core network CN that is, for example, an ATM and/or STH interface module. Furthermore, the terminating device T2 and the base station BS have input means, for example a keyboard, and output means, for example a liquid-crystal display (LCD), that are not shown. Internal connections are indicated only by arrows for reasons of clarity.

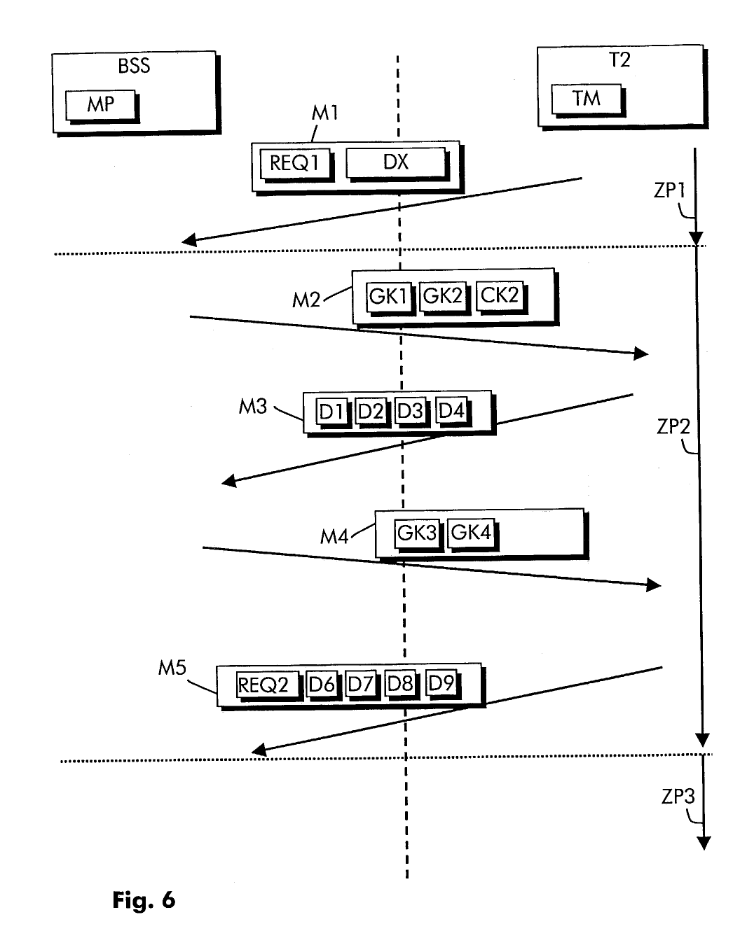

A communication according to the invention between the terminating device T2 and the base station BS is explained below with reference to FIG. 6. An expanded MAC (=medium access protocol) according to the invention, for example based on IEEE 802.16 or ETSI BRAN HA DLC TS (IEEE=Institute of Electrical and Electronic Engineers; ETSI=European Telecommunications Standards Institute; HA=HiperAccess; DLC=data link control; TS=technical specification) is, for example, used for communication.

At the user interface UI, the terminating device T2 receives from the terminal 2 data, for example data packets D1-D9, to be transmitted on the shared medium SM. A policing function PO assesses the contents of the data packets D1-D9 on the basis of predetermined criteria and assigns them accordingly to two service qualities QS1 and QS2: the quality of service QS1 is provided, for example, for data to be transmitted in real time, for example call data, videophony data or the like. The quality of service QS2 is provided, for example, for data for which a transmission delay is not important, for example request commands to the Internet INT or the like. The quality of service QS2 can, for example, be a so-called “best-effort” quality.

Further distinctions of quality of service would be possible. For example, in the case of real-time data, a distinction can be made between data that are to be transmitted at constant data rate (=CBR) and data having variable bit rate (=VBR).

Queues Q1, Q2 are assigned to the quality of service QS1 and queues Q3, Q4 are assigned to the quality of service QS2. The policing function PO or a classifying function, not shown, connected upstream of the latter assigns, for example, the data packets D1 to D5 to the quality of service QS1 and the data packets D6 to D9 to the quality of service QS2. The terminating module TM stores the queues Q1 to Q4, for example, in the memory means MEM.

The queue Q1 is provided for data of a first data category K1 that conform to a specified criterion, for example for data that the terminal 2 has already characterized as data to be transmitted in real time. The queue Q2, on the other hand, is provided for data of a second data category K2 that do not conform to the specified criterion, for example for data that, although they are not characterized as real-time data, the policing function PO or the upstream classifying function determines that they are nevertheless preferably to be transmitted in real time. The policing function PO also arranges, for example, such data in the queue Q2 that cannot be transmitted in the first data category K1 because the transmission capacity provided for said data category K1 is insufficient for transmitting all the data of the quality of service QS1, for example, because of an overload situation. Furthermore, data packets are, for example, assigned as “nonconformal” to the data category K2 if they exceed a predetermined packet size and/or if the time intervals between the data packets are below a predetermined size. The queues Q1, Q2 are assigned to the data categories K1, K2. The same applies analogously to the queues Q3, Q4 that are likewise provided for data conforming to a criterion and for those not conforming to said criterion of quality of service QS2. The queues Q3, Q4 are assigned to data categories K3 and K4 that correspond to the data categories K1 and K2.

The policing function PO arranges the data packets D1-D3 in the queue Q1 assigned to the data category K1 because the data conform to the specified criterion and it arranges the data packets D4, D5 in the queue Q2 corresponding to the data category K2 because the data do not conform to the specified criterion. Correspondingly, the data packets D6 and D7 conforming to one or more criteria relevant for the quality of service QS2 are arranged in the queue Q3 and the data packets D7 and D8 that do not conform are arranged in the queue Q4.

For the transmission of data in the service qualities QS1, QS2, a contractual arrangement, for example, a so-called “service level agreement” (SLA) in which the maximum data quantities that can be transmitted in each of the service qualities QS1 and QS2 are laid down, may exist between the operator of the network NET and the user U2. Each of the terminals 1 to 3 or of the terminating devices T1, T2 and 3 according to the invention can transmit in the present case data in the upstream direction US in the service qualities QS1 and QS2 within a predetermined, for example agreed, transmission capacity in each case.

In the upstream direction US, the base station BS, in particular the medium access controller MC, controls the allocation of the agreed transmission capacity to the terminating devices T1, T2 and T3. The allocation according to the invention of said transmission capacity is explained below on the basis of the terminating device T2.

The terminating device T2 transmits an information item REQ1 about the data to be transmitted on the medium SM to the medium access controller MC. The information item REQ1 indicates, for example, the quantity of data to be transmitted. In this connection, the information item REQ1 indicates, for example, that three or two data packets are to be transmitted in the quality of service QS1 in the data categories for conformal and nonconformal data. Preferably, the filling level of the queues Q1, Q2 is indicated in the information item REQ1. In the present case, the information item REQ1 indicates, for example, that three data packets are awaiting transmission in the upstream direction US in the queue Q1 and two data packets are awaiting transmission in the upstream direction US in each of the queues Q2-Q4.

The information item REQ1 is generated by a transmission function TFR of the terminating module TM. The transmission function TFR can indeed transmit the information item REQ1 in a transmission request configured as a separate message to the medium access controller MC. Said message can be transmitted in the scope of a so-called in-band signaling on the shared medium SM or in the scope of a so-called out-band signaling on a separate signaling path. In the present case, however, the information item REQ1 is contained in a data message M1 as a so-called piggyback, in addition to one or more data packets DX, which piggyback generates the transmission function TFR and is transmitted via the interface AI and via the shared medium SM to the base station BS and, consequently, also to the medium access controller MC.

The medium access controller MC receives the data message M1 at the interface TI. A receiving function MFR of the control module MP extracts the information item REQ1 from the data message M1 and determines from it what transmission capacities are allocated to the terminating device T2 for the transmission of data in the service qualities QS1, QS2. In doing so, the control module MP takes into account what transmission capacity is needed by the further terminating devices T1 and 3 connected to the shared medium SM. For this purpose, there is provided in the control module MP, for example, a table TAB in which the transmission capacities agreed with each of the users U1-U3 for the service qualities QS1 and QS2 and their current use is entered. In addition, the current and/or planned use of the data categories K1-K4 for data conforming or not conforming to the service qualities QS1, QS2 can be entered in the table TAB for each of the service qualities QS1 and QS2.

Planned use of the transmission capacity of the shared medium SM relates, for example, to one allocation period in each case in advance, for which the terminating devices T1, T2 and 3 register their data to be transmitted in the upstream direction US. For example, the message M1 is transmitted in a first allocation period ZP1. The information item REQ1 relates to the allocation of transmission capacity of a second allocation period ZP2 following the first allocation period. The terminating devices T1 and 3 likewise transmit in the present case in the first allocation period ZP1 transmission capacity requirements, corresponding to the message M1, for the allocation period ZP2.

The medium access controller MC executes commands of the control module MP. In accordance with these instructions, it transmits to the terminating device T2 a message M2 comprising an allocation information item GK1, a release information item GK2 and an erase command CK2. The allocation information item GK1 indicates that the terminating module TM is permitted to transmit all the data packets to be transmitted in the data category K1 of the quality of service QS1, in the present case three data packets (D1 to D3), in the allocation period ZP2. However, said three data packets do not completely utilize the transmission capacity provided for the quality of service QS1 on the shared medium SM for the allocation period ZP2. Transmission capacity is still available in the quality of service QS1 in the allocation period ZP2 for a further data packet. For example, a time slot sufficiently large for four data packets is available or time slots for four data packets are available. Accordingly, the release information item GK2 indicates that a further data packet may be transmitted in the data category K2 of the quality of service QS1 in the allocation period ZP2.

The erase command CK2 instructs the terminating device T2 to erase all the superfluous waiting data packets in the data category K2 of the quality of service QS1 because, in the data category K2 of the quality of service QS1, only a single data packet may be transmitted in the second allocation period ZP2. The erase command CK2 relates to the data packet D5. Accordingly, the terminating module TM erases the data packet D5.

The message M2 is analyzed, for example, by a receiving function RT. The latter instructs the transmitting function TFR to transmit the data packets D1-D4 in the manner indicated by the message M2. In a message M3, the terminating module TM transmits the data packets D1 to D4 of the two data categories K1, K2 of the quality of service QS1 taking into account the allocated or released transmission capacity. In doing this, the transmitting function TFR packages the data packets D1 to D4, for example, in one or more so-called frames. The base station BS receives the message M3 and forwards it to the core network CN via the interface NI.

The control module MP then transmits to the terminating device T2 a message M4 comprising an allocation information item GK3 and a release information GK4 that indicate that the terminating module TM may transmit all the data packets to be transmitted in the data categories K3, K4 of the quality of service QS2, in the present case the data packets D6-D9, in the allocation period ZP2. Accordingly, the terminating module TM transmits the data packets D6-D9 to the base station BS in a message M5 on the shared medium SM.

In principle, however, it would also be possible for the control module MP to transmit the information items GK3, GK4 together with the information items GK1, GK2, CK2 as early as in the message M2.

In addition, the message M5 contains an information item REQ2 with which the terminating module TM indicates the quantity of data that are to be transmitted on the medium SM in an allocation period ZP3 following the allocation period ZP2. The information item REQ2 registers, for example, a data packet D10 to be transmitted in the data category K4 of the quality of service QS2.

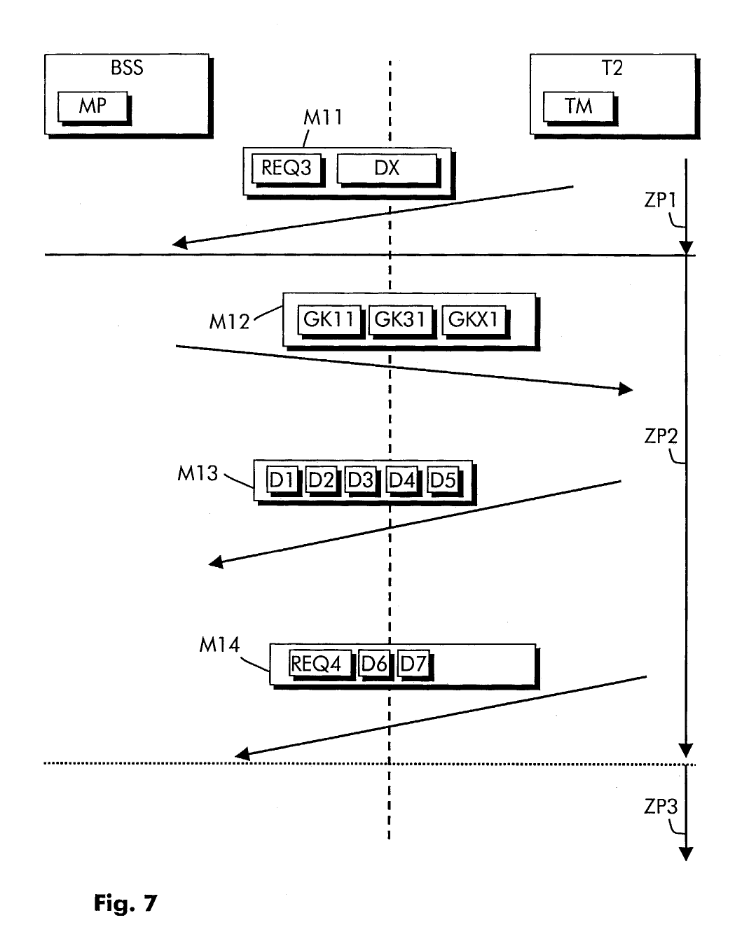

FIG. 7 serves to illustrate a variant of the method according to the invention in accordance with FIG. 6. The terminating device T2 first registers, by means of a message M11 containing an information item REQ3, the data packets D1-D3; D6, D7 awaiting transmission in the data categories K1, K3 for conformal data of the service qualities QS1, QS2 with the medium access controller MC. The information item REQ3 does not contain an indication of nonconformal data to be transmitted in the data categories K2, K4.

The medium access controller MC then determines the size of the transmission capacity of the shared medium SM that is necessary for the “conformal” data packets D1-D3; D6, D7. In doing this, the medium access controller MC can take account only of the terminating device T2 or, what is particularly preferred, it can also take account of one or more further terminating devices connected to the shared medium SM, for example also the terminating devices T1 and 3. The medium access controller MC then determines what transmission capacity the terminating devices T1, T2 and 3 need to transmit “conformal” data in one or more service qualities, for example the service qualities QS1, QS2.

The medium access controller MC allocates, as a matter of priority, transmission capacity of the shared medium SM to the terminating device T2 or all the terminating devices T1, T2 and 3 for the “conformal” data in the two service qualities QS1, QS2. If transmission capacity is then still available, the medium access controller MC releases this unused transmission capacity for the terminating device T2 and/or the further terminating devices T1 and 3 for transmitting “nonconformal” data.

Accordingly, the medium access controller MC responds with a message M12 that contains allocation information items GK11, GK31 and also a release information item GKX1. The allocation information items GK11, GK31 inform the terminating device T2 that it may transmit all the data packets D1-D3, D6, D7 awaiting transmission in the data categories K1, K3 on the shared medium SM. The transmission of the “conformal” data packets D1-D3; D6, D7 and also, if applicable, further “conformal” data packets by the further terminating devices T1 and 3 only partly utilizes the transmission capacity of the shared medium SM. The medium access controller MC therefore releases, by means of the release information item GKX1, unused transmission capacity for the terminating device T2 to transmit two further data packets.

In the present case, the terminating device T2 takes account of the sequence of the data packets when transmitting its data. For example, the data packets D1-D5 form a sequence. The terminating device T2 does not erase any data packet from said sequence, but the data packets D8, D9 of the second data category K4 of the quality of service QS2 instead. This is relevant, for example, if the data packets are ATM cells that are to be transmitted in a predetermined order. In the case of IP data packets, the terminating device T2 does not necessarily have to ensure correct sequencing since such data packets contain an internal sequence number and can consequently be put in a correct order again if necessary by the recipient.

The terminating device T2 uses the transmission capacity released by the release information item GKX1 preferably for transmitting data of as high a quality of service as possible, in this case of the quality of service QS1. This is also a reason for the terminating device T2 to erase, in the present exemplary embodiment, the data packets D8, D9 of the lower quality of service QS2 and not the data packets D4 and D5 of the higher quality of service QS1.

The terminating device T2 first transmits the “conformal” data packets D1-D3 and the “nonconformal” data packets D4, D5 of the quality of service QS1 together in a message M13. The message M13 contains the data packets D1-D5 in a correct order. The terminating device T2 transmits the “conformal” data packets D6, D7 of the quality of service QS2 in a message M14. The terminating device T2 has not received any transmission release for two “nonconformal” data packets. It therefore erases the data packets D8 and D9. The message M14 additionally contains an information item REQ4 about data to be transmitted in the allocation period ZP3 which indicates, for example, that the data packet D10 is to be transmitted in the data category K1.

1. Method for allocating transmission capacity of a shared medium in a multipoint-to-point network, in which the shared medium is provided for a plurality of terminating devices for transmitting data to one point and a network-side medium access controller is provided for allocating transmission capacity of the medium to the terminating devices, comprising the steps of:
grouping of data to be transmitted on the medium in a first data category if the data conform to a specified criterion and in a second data category if the data do not conform to the specified criterion by a terminating device connected to the medium,
allocation of transmission capacity of the medium for the first data category by the medium access controller,
transmission of the data of the first data category on the medium with account being taken of the allocated transmission capacity by the terminating device,
at least partial release of unused transmission capacity available on the shared medium for the transmission of the data of the second data category,
transmission of the data of the second data category on the medium within the scope of the transmission capacity released therefor.

2. Method according to claim 1, characterized in that the transmission capacity released for transmitting data of the second data category is a transmission capacity reserved for transmitting data of the first data category of at least one quality of service.

3. Method according to claim 1, characterized by: transmission of an information item about the data, to be transmitted on the medium, of the first and/or the second data category by the terminating device to the medium access controller and allocation of the transmission capacity for transmitting the data of the first and the second data category by the medium access controller as a function of the information item.

4. Method according to claim 3, characterized in that the information item relates to the quantity and/or the content of the data to be transmitted in each case in the first or the second data category.

5. Method according to claim 1, characterized by transmission of an erase command for at least some of the data grouped in the second data category by the medium access controller if the transmission capacity released for the data of the second data category is not sufficient for their transmission.

6. Method according to claim 1, characterized in that the medium access controller releases the transmission capacity for transmitting the data of the second data category as a function of the quantity of data to be transmitted in each case in the first data categories in the case of all the terminating devices connected to the medium or in the case of a group of terminating devices connected to the medium.

7. Method according to claim 1, characterized by the arrangement of the data, to be transmitted on the medium, of the first data category in a first queue and the data of the second data category in a second queue.

8. Method according to claim 1, characterized by dividing the transmission capacity of the medium into time slots and by allocation of the time slots for the transmission of the data of the first and the second data category.

9. Method according to claim 1, characterized in that the terminating device erases data grouped in the second data category taking into account a predetermined transmission order.

10. Method according to claim 1, characterized in that first and second data categories are provided in each of a plurality of service qualities.

11. Method according to claim 10, characterized in that the medium access controller allocates, as a matter of priority, the transmission capacity of the medium for transmitting data in the first data categories of the service qualities and releases transmission capacity not necessary for the transmission of said data for the transmission of data in second data categories of the service qualities.

12. Medium access controller for allocating transmission capacity of a shared medium in a multipoint-to-point network in which the shared medium is provided for a plurality of terminating devices for the transmission of data to one point, wherein the medium access controller has means, interacting with at least one terminating device,
for allocating transmission capacity available on the medium for a first data category in which data are grouped that are to be transmitted on the medium and conform to a specified criterion, and
for the at least partial release of unused transmission capacity available on the shared medium for transmitting data of a second data category in which data are grouped that are to be transmitted on the medium and do not conform to the specified criterion.

13. Medium access controller according to claim 12, characterized in that it has means for receiving an information item about the data, to be transmitted on the medium, of the first and/or the second data category of a terminating device connected to the medium.

14. Medium access controller according to claim 12, characterized in that the means are configured to release the transmission capacity for the transmission of the data of the second data category as a function of the quantity of data to be transmitted in the first data categories in the case of all the terminating devices connected to the medium, or in the case of a group of terminating devices connected to the medium.

15. Control module for a medium access controller for allocating transmission capacity of a shared medium in a multipoint-to-point network in which the shared medium is provided for a plurality of terminating devices for transmitting data to one point and in which the medium access controller is provided for the allocation of transmission capacity of the medium to the terminating devices, wherein the control module comprises a program code that can be executed by control means of the medium access controller so that the medium access controller can implement the following functions in interaction with at least one of the terminating devices connected to the medium:
allocation of transmission capacity available on the medium for a first data category in which data are grouped that are to be transmitted on the medium and that conform to a specified criterion, and
at least partial release of unused transmission capacity, available on the shared medium, for transmitting data of a second data category in which data are grouped that are to be transmitted on the medium (SM) and do not conform to the specified criterion.

16. Terminating device for allocating transmission capacity of a shared medium in a multipoint-to-point network in which the shared medium is provided for a plurality of terminating devices for transmitting data to one point, and in which a network-side medium access controller is provided for allocating transmission capacity of the medium to the terminating devices, wherein the terminating device can be connected to the medium and has means for
grouping of data, to be transmitted on the medium, in a first data category if the data conform to a specified criterion and in a second data category if the data do not conform with the specified criterion,
receiving an allocation information item about transmission capacity, available on the medium, for the first data category,
transmitting data of the first data category on the medium taking account of the allocated transmission capacity,
receiving a release information item for the at least partial release of unused transmission capacity, available on the shared medium, for the transmission of the data of the second data category, and
transmitting the data of the second data category on the medium within the scope of the transmission capacity released therefor.

17. Terminating device according to claim 16, characterized in that it has means for transmitting an information item about the data, to be transmitted on the medium, of the first and/or the second data category to the medium access controller.

18. Terminating device according to claim 16, characterized in that it has means for arranging data, to be transmitted on the medium, of the first data category in a first queue and the data of the second data category in a second queue.

19. Terminating module for a terminating device for allocating transmitting capacity of a shared medium in a multipoint-to-point network in which the shared medium is provided for a plurality of terminating devices for transmitting data to one point and in which a network-side medium access controller is provided for allocating transmission capacity of the medium to the terminating devices, wherein the terminating module comprises a program code that can be executed by control means of a terminating device that can be connected to the medium so that the terminating device can implement, in the state connected to the medium, in interaction with the medium access controller the following functions:
grouping of data to be transmitted on the medium in a first data category if the data conform to a specified criterion and in a second data category if the data do not conform to the specified criterion,
receiving an allocation information item about transmission capacity, available on the medium, for the first data category,
transmitting the data of the first data category on the medium taking account of the allocated transmission capacity,
receiving a release information item for the at least partial release of unused transmission capacity, available on the shared medium, for the transmission of the data of the second data category, and
transmitting the data of the second data category on the medium within the scope of the transmission capacity released therefor.

20. Multipoint-to-point network for allocating transmission capacity of a shared medium, comprising a shared medium via which a plurality of terminating devices can transmit data to one point, and comprising a network-side-medium access controller for allocating transmission capacity of the medium to the terminating devices having means for implementing the following steps:
grouping of data, to be transmitted on the medium, in a first data category if the data conform to a specified criterion and in a second data category if the data do not conform to the specified criterion by a terminating device connected to the medium,
allocation of transmission capacity of the medium for the first data category by the medium access controller,
transmitting the data of the first data category on the medium with account being taken of the allocated transmission capacity by the terminating device,
at least partial release of unused transmission capacity, available on the shared medium, for the transmission of the data of the second data category, and
transmitting the data of the second data category on the medium within the scope of the transmission capacity released therefor.

21. Computer-readable memory means, in particular diskette or CD-ROM, digital versatile disk, hard disk drive or the like, having a control module for a medium access controller for allocating transmission capacity of a shared medium in a multipoint-to-point network in which the shared medium is provided for a plurality of terminating devices for transmitting data to one point and in which the medium access controller is provided for the allocation of transmission capacity of the medium to the terminating devices, wherein the control module comprises a program code that can be executed by control means of the medium access controller so that the medium access controller can implement the following functions in interaction with at least one of the terminating devices connected to the medium:
allocation of transmission capacity available on the medium for a first data category in which data are grouped that are to be transmitted on the medium and that conform to a specified criterion, and
at least partial release of unused transmission capacity, available on the shared medium, for transmitting data of a second data category in which data are grouped that are to be transmitted on the medium (SM) and do not conform to the specified criterion
and/or having a terminating module for a terminating device for allocating transmitting capacity of a shared medium in a multipoint-to-point network in which the shared medium is provided for a plurality of terminating devices for transmitting data to one point and in which a network-side medium access controller is provided for allocating transmission capacity of the medium to the terminating devices, wherein the terminating module comprises a program code that can be executed by control means of a terminating device that can be connected to the medium so that the terminating device can implement, in the state connected to the medium, in interaction with the medium access controller the following functions:
grouping of data to be transmitted on the medium in a first data category if the data conform to a specified criterion and in a second data category if the data do not conform to the specified criterion,
receiving an allocation information item about transmission capacity, available on the medium, for the first data category,
transmitting the data of the first data category on the medium taking account of the allocated transmission capacity,
receiving a release information item for the at least partial release of unused transmission capacity, available on the shared medium, for the transmission of the data of the second data category, and
transmitting the data of the second data category on the medium within the scope of the transmission capacity released therefor.
